(19) United States
(12) Patent Application Publication
(10) Pub. No.: US 2026/0067859 A1
(43) Pub. Date: Mar. 5, 2026

(54) PERFORMING A POSITIONING MEASUREMENT

(71) Applicant: NOKIA TECHNOLOGIES OY, Espoo (FI)

(72) Inventors: Hyun-Su Cha, Chicago, IL (US); Aki Hekkala, Oulu (FI); Yunchou Xing, Lisle, IL (US); Gilsoo Lee, Lisle, IL (US)

(21) Appl. No.: 18/824,686

(22) Filed: Sep. 4, 2024

(51) Int. Cl. H04W 64/00; H04B 17/309

(52) U.S. Cl. CPC H04W 64/003; H04B 17/309

(57) ABSTRACT

A user device may determine based on a received reference signal from a network node, channel information. The user device may apply as an input to an artificial intelligence and machine learning (AI/ML) model, the channel information. The user device may determine, based on an output of the AI/ML model, whether to measure an upcoming positioning reference signal (PRS) transmitted by the network node. The user device in response to the determination to measure the upcoming PRS, may perform a positioning measurement based on the upcoming PRS. The user device may transmit to the network node the positioning measurement.

### TECHNICAL FIELD

This description relates to wireless communications.

### BACKGROUND

A communication system may be a facility that enables communication between two or more nodes or devices, such as fixed or mobile communication devices. Signals can be carried on wired or wireless carriers.

An example of a cellular communication system is an architecture that is being standardized by the 3rd Generation Partnership Project (3GPP). Long-term evolution (LTE) is referred to as 4G radio-access technology of the Universal Mobile Telecommunications System (UMTS). EUTRA (evolved UMTS Terrestrial Radio Access) is the air interface of 3GPP's Long Term Evolution (LTE) upgrade path for mobile networks. In LTE, base stations or access points (APs), which are referred to as enhanced Node AP (eNBs), provide wireless access within a coverage area or cell. In LTE, mobile devices, or mobile stations are referred to as user equipments (UE). LTE has included a number of improvements or developments. Aspects of LTE are also continuing to improve.

5G New Radio (NR) development is part of a continued mobile broadband evolution process to meet the requirements of 5G, similar to earlier evolution of 3G and 4G wireless networks. In addition, 5G is also targeted at the new emerging use cases in addition to mobile broadband. A goal of 5G is to provide significant improvement in wireless performance, which may include new levels of data rate, latency, reliability, and security. 5G NR may also scale to efficiently connect the massive Internet of Things (IoT) and may offer new types of mission-critical services. For example, ultra-reliable and low-latency communications (URLLC) devices may require high reliability and very low latency. 6G and other networks are also being developed.

### SUMMARY

In some aspects, the techniques described herein relate to an apparatus including: at least one processor; and at least one memory storing instructions that, when executed by the at least one processor, cause the apparatus at least to perform: determining based on a received reference signal from a network node, channel information; applying as an input to an artificial intelligence and machine learning (AI/ML) model the channel information; determining, based on an output of the AI/ML model, whether to measure an upcoming positioning reference signal (PRS) transmitted by the network node; and in response to the determination to measure the upcoming PRS, performing a positioning measurement based on the upcoming PRS, and transmitting to the network node the positioning measurement.

In some aspects, the techniques described herein relate to an apparatus including: at least one processor; and at least one memory storing instructions that, when executed by the at least one processor, cause the apparatus at least to perform: transmitting to a user device, at least one of configuration of an artificial intelligence and machine learning (AI/ML) model, or training information of the AI/ML model, wherein the AI/ML model is used to determine whether to perform a positioning measurement based on an upcoming positioning reference signal (PRS) transmitted by the apparatus; transmitting a PRS for the positioning measurement; and receiving the positioning measurement based on the transmitted PRS.

In some aspects, the techniques described herein relate to a method including: determining by a user device, based on a received reference signal from a network node, channel information; applying as an input to an artificial intelligence and machine learning (AI/ML) model the channel information; determining, based on an output of the AI/ML model, whether to measure an upcoming positioning reference signal (PRS) transmitted by the network node; and in response to the determination to measure the upcoming PRS, performing a positioning measurement based on the upcoming PRS, and transmitting to the network node the positioning measurement.

In some aspects, the techniques described herein relate to a method including: transmitting, by a network node to a user device, at least one of configuration of an artificial intelligence and machine learning (AI/ML) model, or training information of the AI/ML model, wherein the AI/ML model is used to determine whether to perform a positioning measurement based on an upcoming positioning reference signal (PRS) transmitted by the network node; transmitting a PRS for the positioning measurement; and receiving the positioning measurement based on the transmitted PRS.

Other example embodiments are provided or described for each of the example methods, including: means for performing any of the example methods; a non-transitory computer-readable storage medium comprising instructions stored thereon that, when executed by at least one processor, are configured to cause a computing system to perform any of the example methods; and an apparatus including at least one processor, and at least one memory including computer program code, the at least one memory and the computer program code configured to, with the at least one processor, cause the apparatus at least to perform any of the example methods.

The details of one or more examples of embodiments are set forth in the accompanying drawings and the description below. Other features will be apparent from the description and drawings, and from the claims.

### BRIEF DESCRIPTION OF THE DRAWINGS

FIG. 1 is a block diagram of a wireless network 130.

FIG. 2 is a diagram illustrating functional framework for radio access network intelligence based on AI/ML.

FIG. 3A is a diagram illustrating an example of reference signal for wireless channel estimation and positioning.

FIG. 3B is a diagram illustrating an example embodiment for measurement complexity reduction.

FIG. 4 is a diagram illustrating an example embodiment.

FIG. 5 is a flow chart illustrating operation of an apparatus (e.g., which may be a UE or user device, or other apparatus) according to an example embodiment.

FIG. 6 is a flow chart illustrating operation of an apparatus (e.g., which may be a network node or a gNB, or other apparatus) according to an example embodiment.

FIG. 7 is a block diagram of a wireless station or node (e.g., UE, user device, AP, BS, eNB, gNB, RAN node, network node, TRP, or other node) 1300 according to an example embodiment.

### DETAILED DESCRIPTION

It shall be understood that although the terms “first,” “second,” . . . , etc., in front of noun(s) and the like may be used herein to describe various elements, these elements should not be limited by these terms. These terms are only used to distinguish one element from another and they do not limit the order of the noun(s). For example, a first element could be termed a second element, and similarly, a second element could be termed a first element, without departing from the scope of example embodiments. As used herein, the term “and/or” includes any and all combinations of one or more of the listed terms.

As used herein, unless stated explicitly, performing a step “in response to A” does not indicate that the step is performed immediately after “A” occurs and one or more intervening steps may be included.

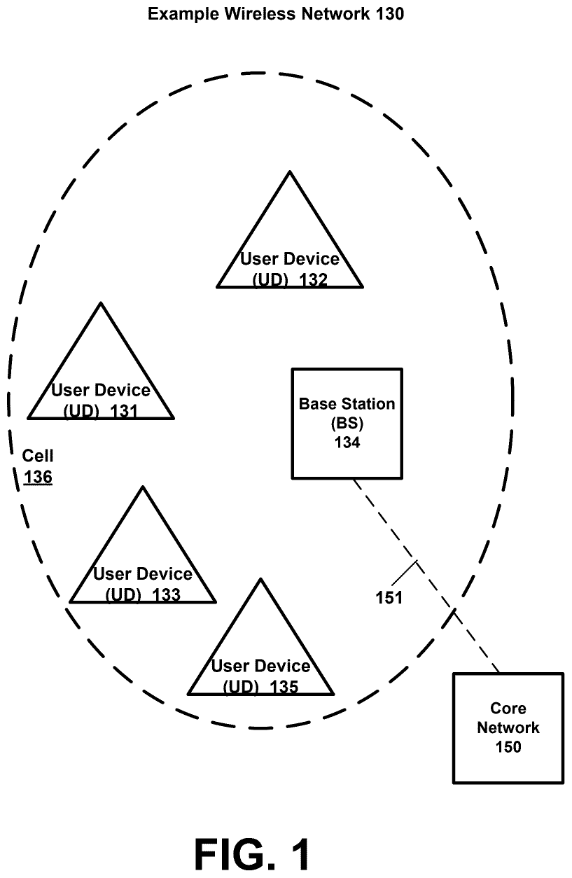

FIG. 1 is a block diagram of a wireless network 130. In the wireless network 130 of FIG. 1, user devices 131, 132, 133 and 135, which may also be referred to as mobile stations (MSs) or user equipment (UEs), may be connected (and in communication) with a base station (BS) 134, which may also be referred to as an access point (AP), an enhanced Node B (eNB), a gNB or a network node. The terms user device and user equipment (UE) may be used interchangeably. A BS may also include or may be referred to as a RAN (radio access network) node, and may include a portion of a BS or a portion of a RAN node, such as e.g., such as a centralized unit (CU) and/or a distributed unit (DU) in the case of a split BS or split gNB. At least part of the functionalities of a BS (e.g., access point (AP), base station (BS) or (c) Node B (eNB), gNB, RAN node) may also be carried out by any node, server or host which may be operably coupled to a transceiver, such as a remote radio head. BS (or AP) 134 provides wireless coverage within a cell 136, including to user devices (or UEs) 131, 132, 133 and 135. Although only four user devices (or UEs) are shown as being connected or attached to BS 134, any number of user devices may be provided. BS 134 is also connected to a core network 150 via a S1 interface 151. This is merely one simple example of a wireless network, and others may be used.

A base station (e.g., such as BS 134) is an example of a radio access network (RAN) node within a wireless network. A BS (or a RAN node) may be or may include (or may alternatively be referred to as), e.g., an access point (AP), a gNB, an eNB, or portion thereof (such as a centralized unit (CU) and/or a distributed unit (DU) in the case of a split BS or split gNB), or other network node.

Some functionalities of the communication network may be carried out, at least partly, in a central/centralized unit, CU, (e.g., server, host or node) operationally coupled to distributed unit, DU, (e.g., a radio head/node). Thus, 5G networks architecture may be based on a so-called CU-DU split. The gNB-CU (central node) may control a plurality of spatially separated gNB-DUs, acting at least as transmit/receive (Tx/Rx) nodes. In some embodiments, however, the gNB-DUs (also called DU) may comprise e.g., a radio link control (RLC), medium access control (MAC) layer and a physical (PHY) layer, whereas the gNB-CU (also called a CU) may comprise the layers above RLC layer, such as a packet data convergence protocol (PDCP) layer, a radio resource control (RRC) and an internet protocol (IP) layer. Other functional splits are possible too.

According to an illustrative example, a BS node (e.g., BS, eNB, gNB, CU/DU, . . . ) or a radio access network (RAN) may be part of a mobile telecommunication system. A RAN (radio access network) may include one or more BSs or RAN nodes that implement a radio access technology, e.g., to allow one or more UEs to have access to a network or core network (CN). Thus, for example, the RAN (RAN nodes, such as BSs or gNBs) may reside between one or more user devices or UEs and a core network. According to an example embodiment, each RAN node (e.g., BS, cNB, gNB, CU/DU, . . . ) or BS may provide one or more wireless communication services for one or more UEs or user devices, e.g., to allow the UEs to have wireless access to a network, via the RAN node. Each RAN node or BS may perform or provide wireless communication services, e.g., such as allowing UEs or user devices to establish a wireless connection to the RAN node, and sending data to and/or receiving data from one or more of the UEs. For example, after establishing a connection to a UE, a RAN node or network node (e.g., BS, eNB, gNB, CU/DU, . . . ) may forward data to the UE that is received from a network or the core network, and/or forward data received from the UE to the network or core network. RAN nodes or network nodes (e.g., BS, CNB, gNB, CU/DU, . . . ) may perform a wide variety of other wireless functions or services, e.g., such as broadcasting control information (e.g., such as system information or on-demand system information) to UEs, paging UEs when there is data to be delivered to the UE, assisting in handover of a UE between cells, scheduling of resources for uplink data transmission from the UE(s) and downlink data transmission to UE(s), sending control information to configure one or more UEs, and the like. These are a few examples of one or more functions that a RAN node or BS may perform.

A user device or user node (user terminal, user equipment (UE), mobile terminal, handheld wireless device, etc.) may refer to a portable computing device that includes wireless mobile communication devices operating either with or without a subscriber identification module (SIM), including, but not limited to, the following types of devices: a mobile station (MS), a mobile phone, a cell phone, a smartphone, a personal digital assistant (PDA), a handset, a device using a wireless modem (alarm or measurement device, etc.), a laptop and/or touch screen computer, a tablet, a phablet, a game console, a notebook, a vehicle, a sensor, and a multimedia device, as examples, or any other wireless device. It should be appreciated that a user device may also be (or may include) a nearly exclusive uplink only device, of which an example is a camera or video camera loading images or video clips to a network. Also, a user node may include a user equipment (UE), a user device, a user terminal, a mobile terminal, a mobile station, a mobile node, a subscriber device, a subscriber node, a subscriber terminal, or other user node. For example, a user node may be used for wireless communications with one or more network nodes (e.g., gNB, eNB, BS, AP, CU, DU, CU/DU) and/or with one or more other user nodes, regardless of the technology or radio access technology (RAT). In LTE (as an illustrative example), core network 150 may be referred to as Evolved Packet Core (EPC), which may include a mobility management entity (MME) which may handle or assist with mobility/handover of user devices between BSs, one or more gateways that may forward data and control signals between the BSs and packet data networks or the Internet, and other control functions or blocks. Other types of wireless networks, such as 5G (which may be referred to as New Radio (NR)) may also include a core network.

In addition, the techniques described herein may be applied to various types of user devices or data service types, or may apply to user devices that may have multiple applications running thereon that may be of different data service types. New Radio (5G) development may support a number of different applications or a number of different data service types, such as for example: machine type communications (MTC), enhanced machine type communication (eMTC), Internet of Things (IoT), and/or narrowband IoT user devices, enhanced mobile broadband (eMBB), and ultra-reliable and low-latency communications (URLLC). Many of these new 5G (NR)-related applications may require generally higher performance than previous wireless networks.

IoT may refer to an ever-growing group of objects that may have Internet or network connectivity, so that these objects may send information to and receive information from other network devices. For example, many sensor type applications or devices may monitor a physical condition or a status and may send a report to a server or other network device, e.g., when an event occurs. Machine Type Communications (MTC, or Machine to Machine communications) may, for example, be characterized by fully automatic data generation, exchange, processing and actuation among intelligent machines, with or without intervention of humans. Enhanced mobile broadband (eMBB) may support much higher data rates than currently available in LTE.

Ultra-reliable and low-latency communications (URLLC) is a new data service type, or new usage scenario, which may be supported for New Radio (5G) systems. This enables emerging new applications and services, such as industrial automations, autonomous driving, vehicular safety, e-health services, and so on. 3GPP targets in providing connectivity with reliability corresponding to block error rate (BLER) of 10-5 and up to 1 ms U-Plane (user/data plane) latency, by way of illustrative example. Thus, for example, URLLC user devices/UEs may require a significantly lower block error rate than other types of user devices/UEs as well as low latency (with or without requirement for simultaneous high reliability). Thus, for example, a URLLC UE (or URLLC application on a UE) may require much shorter latency, as compared to an eMBB UE (or an eMBB application running on a UE).

The techniques described herein may be applied to a wide variety of wireless technologies or wireless networks, such as 5G (New Radio (NR)), cmWave, and/or mmWave band networks, IoT, MTC, eMTC, cMBB, URLLC, 6G, etc., or any other wireless network or wireless technology. These example networks, technologies or data service types are provided only as illustrative examples.

A user device (or UE) may measure various signals and may transmit one or more measurement reports to the network. For example, a UE may measure reference signals received from one or more network nodes (e.g., gNBs or DUs), including channel state information-reference signals (CSI-RSs) and/or synchronization signal block (SSB) reference signals, demodulation references signals, and/or other reference signals. Based on received reference signals, the UE may measure various signal parameters, e.g., such as reference signal received power (RSRP), reference signal received quality (RSRQ), signal to interference plus noise ratio (SINR), received signal strength indicator (RSSI), or other signal parameter.

The PHY (physical) layer may refer to layer 1 (L1) and MAC (media access control) may refer to layer 2 (L2). RSRP, RSRQ, SINR and RSSI are signal quantities measured at layer 1 (L1). The UE may send L1 measurement reports (e.g., CSI-RS reports, which include measurements of one or more signal parameters for one or more cells) to a gNB, source DU or serving cell. These L1 measurement reports may be sent periodically, for example, or aperiodically. L1/L2 measurement reports may include no averaging or filtering of measurement values or may include less averaging or filtering than what is performed for L3 measurement reports. L1 (or L1/L2) measurement reports may be transmitted by a UE to a serving network node or source DU and may cause the network node to trigger or initiate a L1/L2 triggered mobility (LTM) handover of the UE to another cell. L1 measurements (e.g., RSRP RSRQ, RSSI) may be provided or reported periodically to the DU (MAC/PHY).

A machine learning (ML) model may be used within a wireless network to perform (or assist with performing) one or more tasks. In general, one or more nodes (e.g., BS, gNB, eNB, RAN node, user node, UE, user device, relay node, or other wireless node) within a wireless network may use or employ a ML model, e.g., such as, for example a neural network model (e.g., which may be referred to as a neural network, an artificial intelligence (AI) neural network, an AI neural network model, an AI model, a machine learning (ML) model or algorithm, a model, or other term) to perform, or assist in performing, one or more ML-enabled tasks. Other types of models may also be used. A ML-enabled task may include tasks that may be performed (or assisted in performing) by a ML model, or a task for which a ML model has been trained to perform or assist in performing).

ML-based algorithms or ML models may be used to perform and/or assist with performing a variety of wireless and/or radio resource management (RRM) and/or RAN-related functions or tasks to improve network performance, such as, e.g., in the UE for beam prediction (e.g., predicting a best beam or best beam pair based on measured reference signals), antenna panel or beam control, RRM (radio resource measurement) measurements and feedback (channel state information (CSI) feedback), link monitoring, Transmit Power Control (TPC), etc. In some cases, ML models may be used to improve performance of a wireless network in one or more aspects or as measured by one or more performance indicators or performance criteria.

Models (e.g., neural networks or ML models) may be or may include, for example, computational models used in machine learning made up of nodes organized in layers. The nodes are also referred to as artificial neurons, or simply neurons, and perform a function on provided input to produce some output value. A neural network or ML model may typically require a training period to learn the parameters, i.e., weights, used to map the input to a desired output. The mapping may occur via the function that is learned from a given data for the problem in question. Thus, the weights are weights for the mapping function of the neural network. Each neural network model or ML model may be trained for a particular task.

To provide the output given the input, the ML functionality of a neural network model or ML model should be trained, which may involve learning the proper value for a large number of parameters (e.g., weights and/or biases) for the mapping function (or of the ML functionality of the ML model). For example, the parameters may be used to weight and/or adjust terms in the mapping function. This training may be an iterative process, with the values of the weights and/or biases being tweaked over many (e.g., tens, hundreds and/or thousands) of rounds of training episodes or training iterations until arriving at the optimal, or most accurate, values (or weights and/or biases). In the context of neural networks (neural network models) or ML models, the parameters may be initialized, often with random values, and a training optimizer iteratively updates the parameters (e.g., weights) of the neural network to minimize error in the mapping function. In other words, during each round, or step, of iterative training the network updates the values of the parameters so that the values of the parameters eventually converge to the optimal values.

ML models may be trained in either a supervised or unsupervised manner, as examples. In supervised learning, training examples are provided to the ML model or other machine learning algorithm. A training example includes the inputs and a desired or previously observed output. Training examples are also referred to as labeled data because the input is labeled with the desired or observed output. In the case of a neural network (which may be a specific case of ML model), the network (or ML model) learns the values for the weights used in the mapping function or ML functionality of the ML model that most often result in the desired output when given the training inputs. In unsupervised training, the ML model learns to identify a structure or pattern in the provided input. In other words, the model identifies implicit relationships in the data. Unsupervised learning is used in many machine learning problems and typically requires a large set of unlabeled data.

According to an example embodiment, a ML model may be classified into (or may include) two broad categories (supervised and unsupervised), depending on whether there is a learning “signal” or “feedback” available to a model. Thus, for example, within the field of machine learning, there may be two main types of learning or training of a model: supervised, and unsupervised. The main difference between the two types is that supervised learning is done using known or prior knowledge of what the output values for certain samples of data should be. Therefore, a goal of supervised learning may be to learn a function that, given a sample of data and desired outputs, best approximates the relationship between input and output observable in the data. Unsupervised learning, on the other hand, does not have labeled outputs, so its goal is to infer the natural structure present within a set of data points.

Supervised learning: The computer is presented with example inputs and their desired outputs, and the goal may be to learn a general rule that maps inputs to outputs. Supervised learning may, for example, be performed in the context of classification, where a computer or learning algorithm attempts to map input to output labels, or regression, where the computer or algorithm may map input(s) to a continuous output(s). Common algorithms in supervised learning may include, e.g., logistic regression, naive Bayes, support vector machines, artificial neural networks, and random forests. In both regression and classification, a goal may include finding specific relationships or structure in the input data that allow us to effectively produce correct output data. In some example cases, the input signal may be only partially available or restricted to special feedback. Semi-supervised learning: the computer may be given only an incomplete training signal; a training set with some (often many) of the target outputs missing. Active learning: the computer can only obtain training labels for a limited set of instances (based on a budget), and also may optimize its choice of objects for which to acquire labels. When used interactively, these can be presented to the user for labeling.

Unsupervised learning: No labels are given to the learning algorithm, leaving it on its own to find structure in its input. Some example tasks within unsupervised learning may include clustering, representation learning, and density estimation. In these cases, the computer or learning algorithm is attempting to learn the inherent structure of the data without using explicitly-provided labels. Some common algorithms include k-means clustering, principal component analysis, and auto-encoders. Since no labels are provided, there may be no specific way to compare model performance in most unsupervised learning methods.

In an example, the ML based algorithm may include an artificial intelligence and/or machine learning (AI/ML) algorithm.

In an example, artificial intelligence and/or machine learning (AI/ML) techniques may be implemented to improve the performance of wireless communication systems. The implementation of the AI/ML may include implementation of mechanisms at the network side and the UE side. For example, the AI/ML techniques may enhance data collection for NR and dual connectivity scenarios. The AI/ML model, herein, is exchangeable with AI and ML model, AI or ML model, AI model, or ML model.

In an example, artificial intelligence and machine learning (AI/ML) based methods may be employed for enhancement of positioning accuracy. For example, positioning accuracy enhancements may include direct AI/ML positioning, or AI/ML assisted positioning. For example, for positioning enhancement, training data may be generated by a UE, a gNB, a location management function (LMF), and/or the like for model training. For example, for a LMF-side model inference, input data may be generated by the UE or the gNB and terminated at the LMF. In an example, for a gNB-side model inference, input data may be internally available at the gNB. In an example, for UE-side model inference, input data may be internally available at the UE. In an example, for performance monitoring at the LMF side, calculated performance metrics (if needed) or data needed for performance metric calculation (if needed) may be generated by the UE or the gNB and terminated at LMF. In an example, for performance monitoring at the gNB side, calculated performance metrics (if needed) or data needed for performance metric calculation (if needed) may be generated by at least the gNB.

In an example, artificial intelligence and machine learning (AI/ML) based methods for beam management may be employed in wireless communication systems. In an example, the beam management may include spatial domain beam prediction (e.g., beam management BM-Case1) and time domain beam prediction (e.g., BM-Case2). In an example, the scope of spatial beam prediction (BM-Case1) may be to predict the best TX/RX beams in different spatial locations. In an example, time-domain beam predictions (BM-Case2) may include methods to predict the most likely beam to use for next time instants.

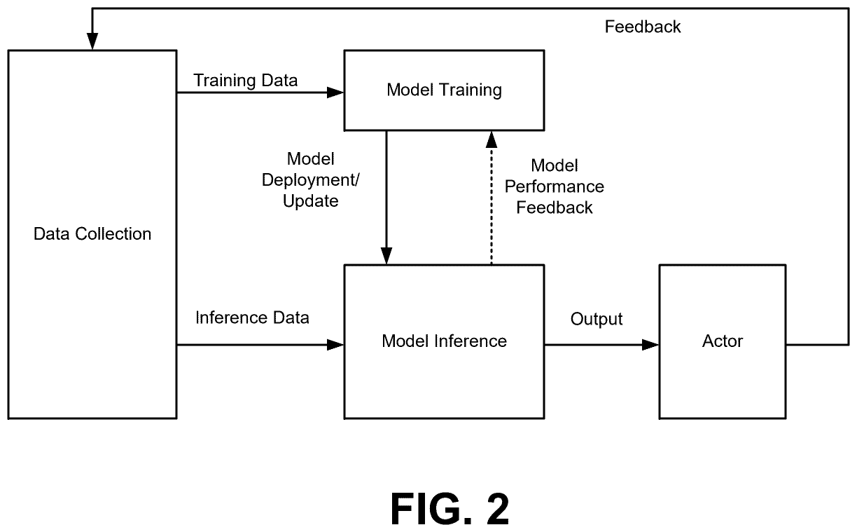

FIG. 2 is a diagram illustrating functional framework for radio access network intelligence based on AI/ML. In an example, data collection may be a function that provides input data to model training and model inference functions. AI/ML algorithm specific data preparation (e.g., data pre-processing and cleaning, formatting, and transformation) may not be carried out in the data collection function. In an example, input data may include measurements from UEs or different network entities, feedback from actor, output from an AI/ML model, and/or the like. In an example, training data may include the data needed as input for the AI/ML model training function.

In an example, inference data may include the data needed as input for the AI/ML model inference function. In an example, model training may be a function that performs the AI/ML model training, validation, and testing which may generate model performance metrics as part of the model testing procedure. The model training function may perform data preparation (e.g., data pre-processing and cleaning, formatting, and transformation) based on training data delivered by a data collection function. In an example, model deployment/update may be employed to initially deploy a trained, validated, and tested AI/ML model to the model inference function or to deliver/provide an updated model to the model inference function. In an example, the model inference may be a function that provides AI/ML model inference output (e.g., predictions or decisions). In an example, the model inference function may provide model performance feedback to model training function. The model inference function may perform data preparation (e.g., data pre-processing and cleaning, formatting, and transformation) based on inference data delivered/provided by a data collection function. In an example, the output may include the inference output of the AI/ML model produced by a model inference function. In an example, the actor may include a function that receives the output from the model inference function and triggers or performs corresponding actions. The actor may trigger actions directed to other entities (of the AI/ML model, network, and/or the like) or to itself. In an example, the feedback may include information that may be needed to derive training data, inference data or to monitor the performance of the AI/ML model and its impact to the network through updating of key performance indicators (KPIs) and performance counters.

In an example embodiment, a UE may be required or configured to perform positioning measurements and transmit the positioning measurements periodically (or aperiodically). For example, the UE may perform the positioning measurements even if the positioning measurements were not performed in an ideal or a suitable channel condition. In other words, the UE may perform positioning measurements based on reference signals that do not satisfy a measurement quality requirement. As a result, the UE may discard the positioning measurements. Performing unnecessary positioning measurements may cause processing overhead thereby additional battery power consumption.

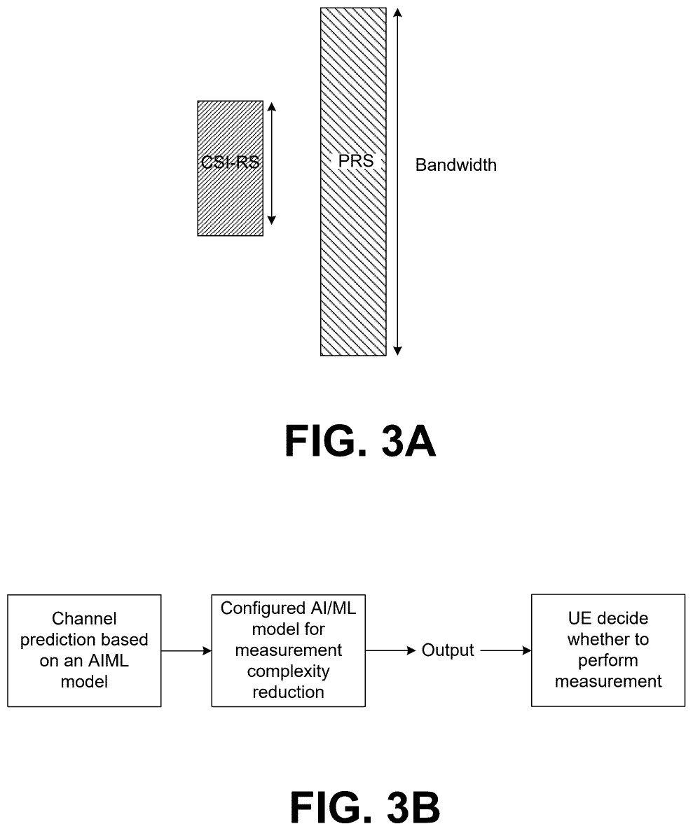

FIG. 3A is a diagram illustrating an example of reference signal for wireless channel estimation and positioning. In an example, channel state information reference signal (CSI-RS) may be used for MIMO channel estimation or beam management. In an example, to obtain accurate positioning measurements, a wideband reference signal may be employed. In an example, the processing complexity to obtain accurate positioning measurements may be substantial. In other words, accurate positioning may require wideband reference signals and complex algorithms such as multiple signal classification (MUSIC) algorithm. In an example, the MUSIC algorithm may be an algorithm used for frequency estimation, propagation time estimation of a wireless signal, and/or radio direction finding.

In existing technologies, a problem may arise when the UE is required or configured to perform frequent positioning measurements, or the UE may employ a reference signal with a wide bandwidth to perform more accurate positioning measurements. For example, when frequent positioning measurements are configured and the channel conditions or quality of refence signals do not meet the measurement quality requirements, the UE may perform the positioning measurements unnecessarily and cause significant resource consumption and reduction of battery life. In another example, when wider bandwidth reference signals are employed, the positioning measurements are more susceptible to failure and may therefore cause unsatisfactory positioning measurements. The problems arise because the UE may perform positioning measurements without consideration of whether an upcoming reference signal employed for positioning measurement(s), location estimation, and/or the like, such as a positioning reference signal (PRS), satisfies a positioning measurement requirement, thereby cause additional resource consumption and battery power.

Therefore, example embodiments are directed to reduction of complexity, processing overhead, and power consumption of the UE based on an AI/ML model, algorithm, or method. In an example, the UE may receive a reference signal (e.g., a CSI-RS, a reference signal used for positioning measurements, such as for example, a PRS, and/or the like) from a gNB. In an example, the UE may determine channel information (e.g., an estimated channel information, a predicted channel information, and/or the like) based on the received reference signal from the gNB. In an example, the UE may apply the channel information as an input to the AI/ML model. In an example, the UE may determine based on an output of the AI/ML model, whether to measure an upcoming positioning reference signal (PRS) transmitted by the gNB. In an example, the PRS may be configured and/or transmitted by the LMF (via the gNB). In an example, in response to the determination to measure the upcoming PRS, the UE may perform a positioning measurement based on the upcoming PRS, and transmit the positioning measurement to the gNB and/or the LMF.

In another example, based on the output of the AI/ML model, the UE may determine not to measure the upcoming PRS transmitted by the gNB. Then the UE may skip the positioning measurement based on the upcoming PRS and therefore skip transmitting the positioning measurement to the gNB.

Therefore, when example embodiments are implemented, the UE may perform positioning measurements only when the upcoming PRS satisfies measurement quality requirements. As a result, implementation of example embodiments results in a more efficient operation of the UE and improved battery performance.

Thus, according to an example embodiment, since performing positioning measurements may require significant overhead and battery power, it is advantageous to avoid performing positioning measurements if those positioning measurements cannot be used for positioning by a network node such as a gNB or a location management function (LMF). For example, to perform accurate positioning measurements, reference signals may be required to meet certain conditions or possess certain characteristics (or attributes). For example, due to dynamics of wireless channels, a quality such as RSRP of the reference signal may change or degrade, and the quality such as RSRP of the reference signal should be above certain threshold. In another example, (reception of) reference signals may be preferred to be in line of sight (LOS) and measured as a LOS measurement. Machine learning (ML) models may be employed for classifying whether a channel (e.g., between the UE and the gNB) is LOS or non-line of sight (NLOS).

In an example, the PRS may be transmitted via a wider bandwidth than the bandwidth of the CSI-RS. The AI/ML model for complexity reduction may consider the bandwidth of the CSI-RS as part of channel bandwidth of a channel used for the upcoming PRS. For example, based on a narrow band CSI-RS, the AIML model may determine whether the upcoming wideband PRS could be used for positioning measurements while satisfying the measurement quality requirements (such as accuracy requirements). In an example, the AI/ML model may determine if the upcoming PRS will be transmitted via LOS channel or not based on a measurement of the narrow band CSI-RS.

FIG. 3B is a diagram illustrating an example embodiment for measurement complexity reduction. In an example embodiment, in 3GPP communication systems such as 5G-advanced and/or 6G, the UE may be able to predict wireless channel conditions from an AI/ML model that is used for obtaining channel information or for predicting a channel quality. In an example, the input of the AI/ML model (that is used for complexity reduction) may be the output of the AI/ML model for prediction of wireless channel conditions. In an example, the channel information as the input of the AI/ML model used for complexity reduction may include channel prediction that is the output of the AI/ML model for channel prediction and/or channel estimation based on received reference signal such as CSI-RS.

In other words, the UE may perform wireless channel measurements and/or estimation based on a reference signal such as the CSI-RS for CSI reporting. The UE may predict channel information or the CSI by using an AI/ML model based on the measured or estimated channel information or CSI. In an example, the estimated or predicted channel (or channel information) may be an input for the AI/ML model that is used for complexity reduction. In an example, one or more UEs may provide their measured CSIs to the network (e.g., a server, a location server, the LMF, and/or the like) to form a training dataset for the AI/ML model(s). In an example, training of the AI/ML model(s) (supervised learning) may be performed by a network node such as LMF. After completion of the training, the trained AI/ML model(s), possibly together with training information such as the training dataset, is provided to the UE(s).

In an example embodiment, the output from the AI/ML model may include an indication of whether to measure the upcoming PRS. For example, the output from the AI/ML model may include an indication of whether the upcoming PRS can meet a measurement quality requirement.

In an example, the output from the AI/ML model may include an information associated with a success probability that the upcoming PRS can meet the measurement quality requirements. For example, the output of the AI/ML model may provide a success probability that the UE can successfully perform positioning measurements.

In an example, the output from the AI/ML model may include an indication of whether the upcoming PRS can meet the measurement quality requirement with the success probability being greater than or equal to a first threshold value (e.g., P1).

In an example, the output from the AI/ML model may include a first time duration for which one or more upcoming PRSs can meet the measurement quality requirement with the success probability being greater than or equal to the first threshold value. In another example, the output from the AI/ML model may include a second time duration for which the positioning measurement based on the upcoming PRS should be skipped (paused or stopped). For example, the positioning measurements may be skipped for a period of time being equal to the second time duration. Then during the period of time equal to the second time duration, the UE may determine not to perform positioning measurements based on the upcoming PRSs. After the second time duration, the UE may assess or determine whether to perform the positioning measurements based on the upcoming PRSs.

In an example, the measurement quality requirement may include timing information of a positioning measurement, a reference signal received power (RSRP) of a reference signal (RS) that is used for the positioning measurement, and/or the like. In an example, the measurement quality requirement may include accuracy of the positioning measurement. For example, the measurement quality requirement may include measurement accuracy requirement. In an example, the positioning measurements may include timing measurements of reference signals (e.g., time of arrival (TOA), time difference of arrival (TDOA), and/or the like), reference signal time difference (RSTD), carrier phase measurements of reference signals, and/or the like. In an example, the first threshold value and/or the measurement quality requirement may be determined by the network, e.g., the gNB, the LMF, and/or the like.

The UE may use the (received) AI/ML model(s) to obtain/determine channel information and to classify whether the channel (or a wireless channel) may satisfy measurement quality requirement(s) for positioning measurement. For example, if the UE receives PRSs through the channel or through a wider channel, the UE may use the AI/ML model to classify the channel and determine whether an upcoming PRS can meet the measurement quality requirement(s).

In an example, the AI/ML model may indicate information for the classification. For example, based on the estimated channel information or the predicted channel information, the output of the AI/ML model may indicate that the upcoming PRS may be used for the positioning measurements within X1 time unit (e.g., in milliseconds) with a success probability P1 (e.g., the first threshold value). In another example, the output of the AI/ML model may be a failure probability instead.

In an example, the output of the AI/ML model may indicate that the upcoming PRS(s) cannot meet the measurement quality requirement with the success probability being greater than or equal to the first threshold value (e.g., P1). Then the UE may consider a second threshold value (e.g., P2). For example, the second threshold value (P2) may be smaller than the first threshold value (P1), e.g., P2<P1. In an example, the UE may receive the second threshold value (P2) from the network node, the gNB, the LMF, and/or the like.

In other words, in case there is no chance that the UE can obtain any satisfactory positioning measurement within X1 time units with success probability P1, the UE may determine or use another threshold for the success probability being a lower probability threshold, e.g., the second threshold (P2<P1). The second threshold may be configured by the network, e.g., the gNB, the LMF, and/or the like. Additionally, or alternatively, if the UE cannot obtain measurements, then the UE may reduce the success probability value (or condition) and use different threshold values for the success probability. In an example embodiment, the UE may change the time duration for which one or more upcoming PRSs can meet the measurement quality requirement with the success probability.

In an example, the UE may receive from the gNB, the measurement quality requirement and/or the first threshold value. Then the UE may determine whether to measure the upcoming PRS by comparing the success probability with the first threshold value, e.g., P1. In an example, the UE may determine not to perform the positioning measurement or skip the positioning measurement for a time period shorter than the second time duration, e.g., based on at least one of a mobility condition, a variation of a channel quality, a variation of channel state, a predicted channel quality over the time period (duration), and/or the like. In an example, the variation of channel state may include existence and/or strength of a line of sight signal path between the UE and a transmission and reception point (TRP). In an example, the second time duration may be indicated by the output of AI/ML model at the UE. The second time duration may indicate a time period (or duration) for which the positioning measurement based on the upcoming PRS should be skipped.

In an example embodiment, the UE may receive from the network node, at least one of configuration of the AI/ML model, training information of the AI/ML model, and/or the like. In an example, the AI/ML model may be employed by the UE to determine whether to perform the positioning measurement based on the upcoming PRS. In an example, the UE may receive from the network node (e.g., the gNB, and/or the LMF), an indication to perform an overhead reduction of positioning measurements by using the AI/ML model.

In an example, the channel information may include at least one of an estimated channel information, a predicted channel information, and/or the like. In an example, the channel information may be determined based on a measurement of a reference signal. For example, the reference signal may include at least one of a CSI-RS, a PRS, and/or the like.

In an example embodiment, the measurement quality requirement may include at least one of: timing information of the positioning measurement, a reference signal received power (RSRP) of a reference signal that is used for the positioning measurement, and/or the like.

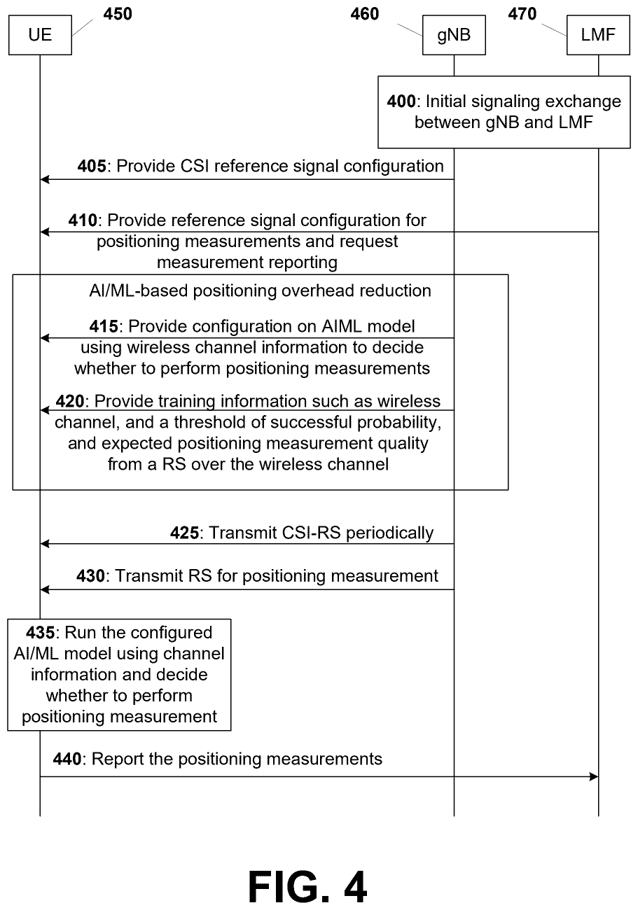

FIG. 4 is a diagram illustrating an example embodiment. At step 400, a gNB (one or more) 460 may select a LMF 470 and the LMF 470 may be configured with the gNB 460. In an example, exchange of signaling between the gNB 460 and the LMF 470 may be via an access and mobility management function (AMF) or other core network elements. At step 405, the gNB 460 may provide the UE 450 with a reference signal configuration for wireless channel estimation such as a CSI-RS. The UE 450 may also be configured to report the estimated or predicted channel information. For example, the gNB 460 may provide the CSI-RS configuration to allow the UE to measure channel information for channel between the UE 450 and the gNB 460. At step 410, the LMF 470 may provide reference signal configuration for reference signal used for positioning measurements such as positioning reference signals so that the UE 450 can perform positioning measurements. In an example, the UE 450 may receive one or more PRS transmissions (or PRS configurations) from one or more gNBs and LMFs. In an example, the positioning measurements may include timing measurements, phase measurements, power measurements such as RSRP, and/or the like. The UE 450 may be configured by the LMF 470 to perform positioning measurements. The UE 450 may also be configured by the LMF 470 to report the obtained positioning measurements to the LMF 470. In an example, the signaling between the LMF 470 and the UE 450 may be via the gNB 460. In an example, the UE 450 may receive the PRS configuration from the LMF 470 and via the gNB 460. For example, the PRS configuration may be transmitted from the gNB 460 to the UE 450 by using a physical downlink shared channel (PDSCH).

At step 415 of FIG. 4, the gNB 460 may configure the UE 450 with an (network node off-line trained) AI/ML model. The AI/ML model may include an AI/ML mode for channel prediction and an AI/ML model for overhead reduction. The gNB 460 may configure the UE 450 (or indicate to the UE 450) to perform an overhead reduction behavior of (selective) positioning measurement using the configured AI/ML model(s).

At step 420, the UE 450 may receive from the gNB 460, at least one of the measurement quality requirements or the first threshold value (e.g., P1). In an example, the UE may receive the training information for the configured AI/ML model(s). It is noted that the information transmitted at steps 415 and 425 may be carried in one or more messages.

At step 425 of FIG. 4, the UE 450 may receive from the gNB 460, reference signals such as a CSI-RS, and/or the like. In an example, the gNB may transmit the reference signals periodically. At step 430, the UE 450 may receive from the gNB 460, a reference signal for positioning measurement. The reference signal for the positioning measurement may be a PRS.

At step 435 of FIG. 4, the UE may run the AI/ML model(s) to perform channel estimation and/or prediction. In an example, the UE 450 may run the configured AI/ML model/algorithm for overhead reduction. The output of AI/ML model for overhead reduction may provide information or indications on whether an upcoming RSs or upcoming PRSs within a period of time (e.g., X time units) could be used for successful positioning measurement with a success probability of P1 (or the first threshold value). If there are (satisfactory) RSs for positioning measurements in the next X time units, the UE 450 may perform the positioning measurements. At step 440 of FIG. 4, the UE may transmit the positioning measurements to the LMF 470 via the gNB 460.

In an example embodiment, the gNB may transmit to the UE, an indication to perform an overhead reduction of positioning measurements by using the AI/ML model. For example, the configured AI/ML model may use (as input(s)) an estimated channel information of a current time slot or predicted channel information of a future time slot, and an output of the AI/ML model may include at least one of an indication of whether an upcoming PRS transmitted from a same transmission reception point (TRP) or the gNB 460 may satisfy a measurement quality requirement. For example, the output of the AI/ML model or the indication may be a binary decision on whether the upcoming PRS(s) or the future PRS(s) (e.g., a PRS of a next time slot or a next two time slots) meet the measurement quality requirement. In an example, the indication may include a time duration or a time period for which the positioning measurement based on the PRS is valid and satisfies the measurement quality requirement). In an example, the indication may include a success probability or failure probability that the PRS can satisfy the measurement quality requirement. As an example, the AI/ML model output may indicate that if positioning measurements are performed on the PRS during the next 5 ms, there may be a 90% probability of failure (10% probability of success).

In an example embodiment, overhead reduction techniques of example embodiments may employ positioning methods that are based on uplink reference signals such as a sounding reference signal (SRS). Example embodiments may be implemented on a network node such as a gNB, a LMF, and/or the like.

Example embodiments may be implemented (applicable) for the uplink direction where a sounding reference signal (SRS) may be employed for positioning. For example, the positioning measurement may be performed by a network node such as a gNB based on an uplink SRS. Moreover, example embodiments may be implemented to reduce overhead for other types of measurements (e.g., other than positioning measurements).

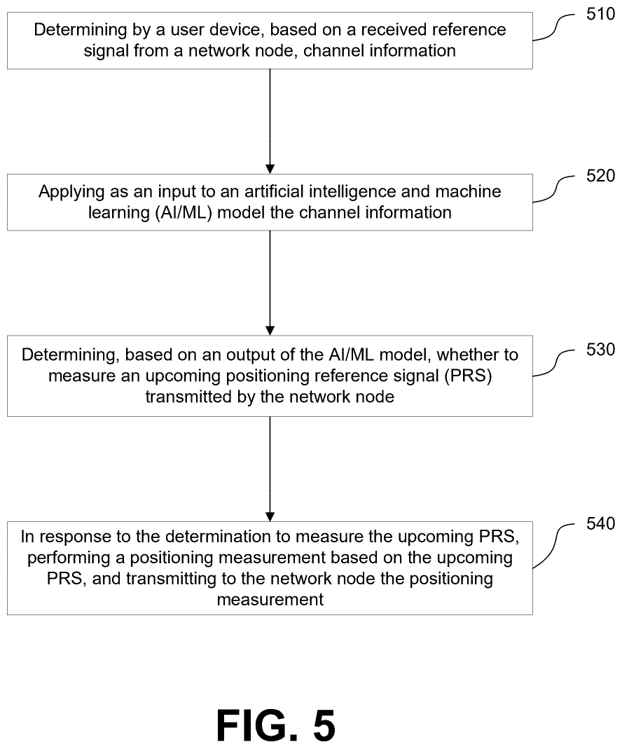

FIG. 5 is a flow chart illustrating operation of an apparatus (e.g., which may be a UE or user device, or other apparatus) according to an example embodiment. Operation 510 includes determining by a user device, based on a received reference signal from a network node, channel information. Operation 520 includes applying as an input to an artificial intelligence and machine learning (AI/ML) model the channel information. Operation 530 includes determining, based on an output of the AI/ML model, whether to measure an upcoming positioning reference signal (PRS) transmitted by the network node. Operation 540 includes in response to the determination to measure the upcoming PRS, performing a positioning measurement based on the upcoming PRS, and transmitting to the network node the positioning measurement.

With respect to the method of FIG. 5, the method may further include: wherein the output from the AI/ML model includes at least one of: an indication of whether to measure the upcoming PRS; an indication of whether the positioning measurement based on the upcoming PRS can meet a measurement quality requirement; an information associated with a success probability that the positioning measurement based on the upcoming PRS can meet the measurement quality requirement; an indication whether the positioning measurement based on the upcoming PRS can meet the measurement quality requirement with the success probability being greater than or equal to a first threshold value; a first time duration for which the positioning measurement based on one or more upcoming PRSs can meet the measurement quality requirement with the success probability being greater than or equal to the first threshold value; or a second time duration for which the positioning measurement based on the upcoming PRS can be skipped.

With respect to the method of FIG. 5, the method may further include: wherein the measurement quality requirement includes at least one of: timing information of the positioning measurement; an expected measurement accuracy of the measurement; or a reference signal received power (RSRP) of a reference signal (RS) that is used for the positioning measurement.

With respect to the method of FIG. 5, the method may further include: receiving from the network node, at least one of the measurement quality requirements or the first threshold value.

With respect to the method of FIG. 5, the method may further include: wherein the determining whether to measure the upcoming PRS includes comparing the success probability with the first threshold value.

With respect to the method of FIG. 5, the method may further include: skipping the positioning measurement for a time period shorter than the second time duration, based on at least one of: a mobility condition; a variation of a channel quality; a variation of a channel state; or a predicted channel quality over the time period.

With respect to the method of FIG. 5, the method may further include: in response to an indication that the positioning measurement based on the upcoming PRS cannot meet the measurement quality requirement with the success probability being greater than or equal to the first threshold value, comparing the success probability with a second threshold value smaller than the first threshold value.

With respect to the method of FIG. 5, the method may further include: receiving from the network node, the second threshold value.

With respect to the method of FIG. 5, the method may further include: receiving, by the user device from the network node, at least one of configuration of the AI/ML model, or training information of the AI/ML model, wherein the AI/ML model is used to determine whether to perform the positioning measurement based on the upcoming PRS.

With respect to the method of FIG. 5, the method may further include: receiving, by the user device from the network node, an indication to perform an overhead reduction of positioning measurements by using the AI/ML model.

With respect to the method of FIG. 5, the method may further include: wherein the channel information is at least one of: an estimated channel information; or a predicted channel information.

With respect to the method of FIG. 5, the method may further include: wherein the channel information is determined based on a measurement of a reference signal (RS), wherein the RS includes a channel state information reference signal (CSI-RS).

With respect to the method of FIG. 5, the method may further include: determining, based on the output of the AI/ML model, not to measure the upcoming PRS transmitted by the network node; and in response to the determination not to measure the upcoming PRS: skipping the performing the positioning measurement based on the upcoming PRS; and skipping transmitting to the network node the positioning measurement.

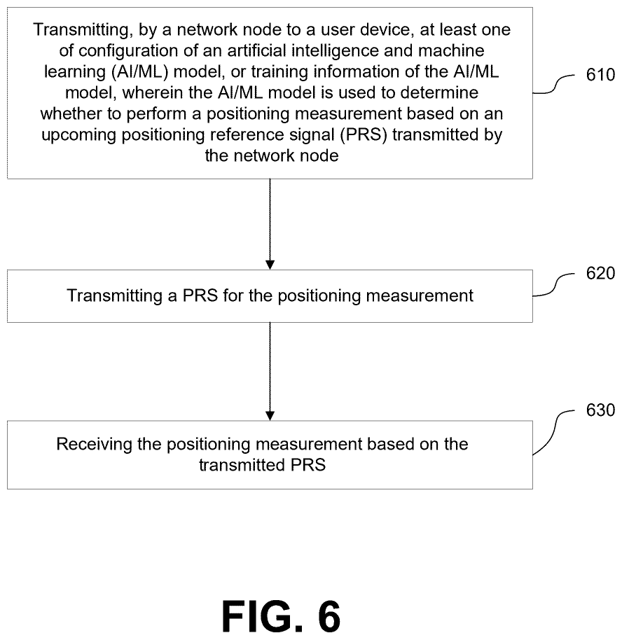

FIG. 6 is a flow chart illustrating operation of an apparatus (e.g., which may be a network node or a gNB, or other apparatus) according to an example embodiment. Operation 610 includes transmitting, by a network node to a user device, at least one of configuration of an artificial intelligence and machine learning (AI/ML) model, or training information of the AI/ML model, wherein the AI/ML model is used to determine whether to perform a positioning measurement based on an upcoming positioning reference signal (PRS) transmitted by the network node. Operation 620 includes transmitting a PRS for the positioning measurement. Operation 630 includes receiving the positioning measurement based on the transmitted PRS.

With respect to the method of FIG. 6, the method may further include: wherein an output from the AI/ML model includes at least one of: an indication of whether to measure the upcoming PRS; an indication of whether the positioning measurement based on the upcoming PRS can meet a measurement quality requirement; an information associated with a success probability that the positioning measurement based on the upcoming PRS can meet the measurement quality requirement; an indication whether the positioning measurement based on the upcoming PRS can meet the measurement quality requirement with the success probability being greater than or equal to a first threshold value; a first time duration for which the positioning measurement based on one or more upcoming PRSs can meet the measurement quality requirement with the success probability being greater than or equal to the first threshold value; or a second time duration for which the positioning measurement based on the upcoming PRS should be skipped.

With respect to the method of FIG. 6, the method may further include transmitting by the network node, at least one of the measurement quality requirements or the first threshold value.

With respect to the method of FIG. 6, the method may further include wherein the measurement quality requirement includes at least one of: timing information of a measurement; an expected measurement accuracy of the measurement; or a reference signal received power (RSRP) of a reference signal (RS) that is used for the measurement.

With respect to the method of FIG. 6, the method may further include transmitting to the user device, an indication to perform an overhead reduction of positioning measurements by using the AI/ML model.

With respect to the method of FIG. 6, the method may further include transmitting to a location management function (LMF), the positioning measurement.

Some examples will now be described, based on the description and figures provided herein.

Example 1. An apparatus including: at least one processor; and at least one memory storing instructions that, when executed by the at least one processor, cause the apparatus at least to perform: determining based on a received reference signal from a network node, channel information; applying as an input to an artificial intelligence and machine learning (AI/ML) model the channel information; determining, based on an output of the AI/ML model, whether to measure an upcoming positioning reference signal (PRS) transmitted by the network node; and in response to the determination to measure the upcoming PRS, performing a positioning measurement based on the upcoming PRS, and transmitting to the network node the positioning measurement.

Example 2. The apparatus of Example 1, wherein the output from the AI/ML model includes at least one of: an indication of whether to measure the upcoming PRS; an indication of whether the positioning measurement based on the upcoming PRS can meet a measurement quality requirement; an information associated with a success probability that the positioning measurement based on the upcoming PRS can meet the measurement quality requirement; an indication whether the positioning measurement based on the upcoming PRS can meet the measurement quality requirement with the success probability being greater than or equal to a first threshold value; a first time duration for which the positioning measurement based on one or more upcoming PRSs can meet the measurement quality requirement with the success probability being greater than or equal to the first threshold value; or a second time duration for which the positioning measurement based on the upcoming PRS can be skipped.

Example 3. The apparatus of Example 2, wherein the measurement quality requirement includes at least one of: timing information of the positioning measurement; an expected measurement accuracy of the measurement; or a reference signal received power (RSRP) of a reference signal (RS) that is used for the positioning measurement.

Example 4. The apparatus of Example 2 or 3, wherein the apparatus is further caused to perform receiving from the network node, at least one of the measurement quality requirements or the first threshold value.

Example 5. The apparatus of any of Examples 2 to 4, wherein the determining whether to measure the upcoming PRS includes comparing the success probability with the first threshold value.

Example 6. The apparatus of any of Examples 2 to 5, wherein the apparatus is further caused to perform skipping the positioning measurement for a time period shorter than the second time duration, based on at least one of: a mobility condition; a variation of a channel quality; a variation of a channel state; or a predicted channel quality over the time period.

Example 7. The apparatus of any of Examples 2 to 6, wherein the apparatus is further caused to perform in response to an indication that the positioning measurement based on the upcoming PRS cannot meet the measurement quality requirement with the success probability being greater than or equal to the first threshold value, comparing the success probability with a second threshold value smaller than the first threshold value.

Example 8. The apparatus of Example 7, wherein the apparatus is further caused to perform receiving from the network node, the second threshold value.

Example 9. The apparatus of any of Examples 1 to 8, wherein the apparatus is further caused to perform receiving, by the apparatus from the network node, at least one of configuration of the AI/ML model, or training information of the AI/ML model, wherein the AI/ML model is used to determine whether to perform the positioning measurement based on the upcoming PRS.

Example 10. The apparatus of any of Examples 1 to 9, wherein the apparatus is further caused to perform receiving, by the apparatus from the network node, an indication to perform an overhead reduction of positioning measurements by using the AI/ML model.

Example 11. The apparatus of any of Examples 1 to 10, wherein the channel information is at least one of: an estimated channel information; or a predicted channel information.

Example 12. The apparatus of any of Examples 1 to 11, wherein the channel information is determined based on a measurement of a reference signal (RS), wherein the RS includes a channel state information reference signal (CSI-RS).

Example 13. The apparatus of any of Examples 1 to 12, wherein the apparatus is further caused to perform: determining, based on the output of the AI/ML model, not to measure the upcoming PRS transmitted by the network node; and in response to the determination not to measure the upcoming PRS: skipping the performing the positioning measurement based on the upcoming PRS; and skipping transmitting to the network node the positioning measurement.

Example 14. An apparatus including: at least one processor; and at least one memory storing instructions that, when executed by the at least one processor, cause the apparatus at least to perform: transmitting to a user device, at least one of configuration of an artificial intelligence and machine learning (AI/ML) model, or training information of the AI/ML model, wherein the AI/ML model is used to determine whether to perform a positioning measurement based on an upcoming positioning reference signal (PRS) transmitted by the apparatus; transmitting a PRS for the positioning measurement; and receiving the positioning measurement based on the transmitted PRS.

Example 15. The apparatus of Example 14, wherein an output from the AI/ML model includes at least one of: an indication of whether to measure the upcoming PRS; an indication of whether the positioning measurement based on the upcoming PRS can meet a measurement quality requirement; an information associated with a success probability that the positioning measurement based on the upcoming PRS can meet the measurement quality requirement; an indication whether the positioning measurement based on the upcoming PRS can meet the measurement quality requirement with the success probability being greater than or equal to a first threshold value; a first time duration for which the positioning measurement based on one or more upcoming PRSs can meet the measurement quality requirement with the success probability being greater than or equal to the first threshold value; or a second time duration for which the positioning measurement based on the upcoming PRS should be skipped.

Example 16. The apparatus of Example 15, wherein the apparatus is further caused to perform transmitting by the apparatus, at least one of the measurement quality requirements or the first threshold value.

Example 17. The apparatus of Example 16, wherein the measurement quality requirement includes at least one of: timing information of a measurement; an expected measurement accuracy of the measurement; or a reference signal received power (RSRP) of a reference signal (RS) that is used for the measurement.

Example 18. The apparatus of any of Examples 14 to 17, wherein the apparatus is further caused to perform transmitting to the user device, an indication to perform an overhead reduction of positioning measurements by using the AI/ML model.

Example 19. The apparatus of any of Examples 14 to 18, wherein the apparatus is further caused to perform transmitting to a location management function (LMF), the positioning measurement.

Example 20. A method including: determining by a user device, based on a received reference signal from a network node, channel information; applying as an input to an artificial intelligence and machine learning (AI/ML) model the channel information; determining, based on an output of the AI/ML model, whether to measure an upcoming positioning reference signal (PRS) transmitted by the network node; and in response to the determination to measure the upcoming PRS, performing a positioning measurement based on the upcoming PRS, and transmitting to the network node the positioning measurement.

Example 21. The method of Example 20, wherein the output from the AI/ML model includes at least one of: an indication of whether to measure the upcoming PRS; an indication of whether the positioning measurement based on the upcoming PRS can meet a measurement quality requirement; an information associated with a success probability that the positioning measurement based on the upcoming PRS can meet the measurement quality requirement; an indication whether the positioning measurement based on the upcoming PRS can meet the measurement quality requirement with the success probability being greater than or equal to a first threshold value; a first time duration for which the positioning measurement based on one or more upcoming PRSs can meet the measurement quality requirement with the success probability being greater than or equal to the first threshold value; or a second time duration for which the positioning measurement based on the upcoming PRS can be skipped.

Example 22. The method of Example 21, wherein the measurement quality requirement includes at least one of: timing information of the positioning measurement; an expected measurement accuracy of the measurement; or a reference signal received power (RSRP) of a reference signal (RS) that is used for the positioning measurement.

Example 23. The method of Example 21 or 22, further including receiving from the network node, at least one of the measurement quality requirements or the first threshold value.

Example 24. The method of any of Examples 21 to 23, wherein the determining whether to measure the upcoming PRS includes comparing the success probability with the first threshold value.

Example 25. The method of any of Examples 21 to 24, further including skipping the positioning measurement for a time period shorter than the second time duration, based on at least one of: a mobility condition; a variation of a channel quality; a variation of a channel state; or a predicted channel quality over the time period.

Example 26. The method of any of Examples 21 to 25, further including in response to an indication that the positioning measurement based on the upcoming PRS cannot meet the measurement quality requirement with the success probability being greater than or equal to the first threshold value, comparing the success probability with a second threshold value smaller than the first threshold value.

Example 27. The method of Example 26, further including receiving from the network node, the second threshold value.

Example 28. The method of any of Examples 20 to 27, further including receiving, by the user device from the network node, at least one of configuration of the AI/ML model, or training information of the AI/ML model, wherein the AI/ML model is used to determine whether to perform the positioning measurement based on the upcoming PRS.

Example 29. The method of any of Examples 20 to 28, further including receiving, by the user device from the network node, an indication to perform an overhead reduction of positioning measurements by using the AI/ML model.

Example 30. The method of any of Examples 20 to 29, wherein the channel information is at least one of: an estimated channel information; or a predicted channel information.

Example 31. The method of any of Examples 20 to 30, wherein the channel information is determined based on a measurement of a reference signal (RS), wherein the RS includes a channel state information reference signal (CSI-RS).

Example 32. The method of any of Examples 20 to 31, further including: determining, based on the output of the AI/ML model, not to measure the upcoming PRS transmitted by the network node; and in response to the determination not to measure the upcoming PRS: skipping the performing the positioning measurement based on the upcoming PRS; and skipping transmitting to the network node the positioning measurement.

Example 33. A method including: transmitting, by a network node to a user device, at least one of configuration of an artificial intelligence and machine learning (AI/ML) model, or training information of the AI/ML model, wherein the AI/ML model is used to determine whether to perform a positioning measurement based on an upcoming positioning reference signal (PRS) transmitted by the network node; transmitting a PRS for the positioning measurement; and receiving the positioning measurement based on the transmitted PRS.

Example 34. The method of Example 33, wherein an output from the AI/ML model includes at least one of: an indication of whether to measure the upcoming PRS; an indication of whether the positioning measurement based on the upcoming PRS can meet a measurement quality requirement; an information associated with a success probability that the positioning measurement based on the upcoming PRS can meet the measurement quality requirement; an indication whether the positioning measurement based on the upcoming PRS can meet the measurement quality requirement with the success probability being greater than or equal to a first threshold value; a first time duration for which the positioning measurement based on one or more upcoming PRSs can meet the measurement quality requirement with the success probability being greater than or equal to the first threshold value; or a second time duration for which the positioning measurement based on the upcoming PRS should be skipped.

Example 35. The method of Example 34, further including transmitting by the network node, at least one of the measurement quality requirements or the first threshold value.

Example 36. The method of Example 35, wherein the measurement quality requirement includes at least one of: timing information of a measurement; an expected measurement accuracy of the measurement; or a reference signal received power (RSRP) of a reference signal (RS) that is used for the measurement.

Example 37. The method of any of Examples 33 to 36, further including transmitting to the user device, an indication to perform an overhead reduction of positioning measurements by using the AI/ML model.

Example 38. The method of any of Examples 33 to 37, further including transmitting to a location management function (LMF), the positioning measurement.

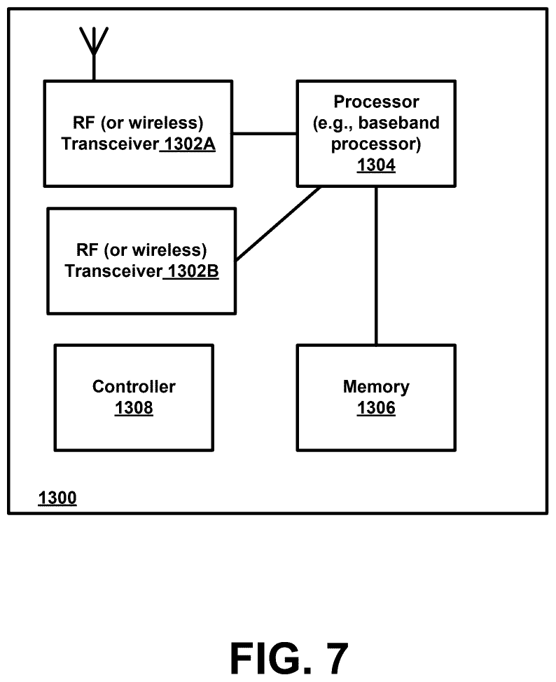

FIG. 7 is a block diagram of a wireless station or node (e.g., UE, user device, AP, BS, eNB, gNB, RAN node, network node, TRP, or other node) 1300 according to an example embodiment. The wireless station 1300 may include, for example, one or more (e.g., two as shown in FIG. 7) RF (radio frequency) or wireless transceivers 1302A, 1302B, where each wireless transceiver includes a transmitter to transmit signals and a receiver to receive signals. The wireless station also includes a processor or control unit/entity (controller) 1304 to execute instructions or software and control transmission and receptions of signals, and a memory 1306 to store data and/or instructions.

Processor 1304 may also make decisions or determinations, generate frames, packets or messages for transmission, decode received frames or messages for further processing, and other tasks or functions described herein. Processor 1304, which may be a baseband processor, for example, may generate messages, packets, frames or other signals for transmission via wireless transceiver 1302 (1302A or 1302B). Processor 1304 may control transmission of signals or messages over a wireless network, and may control the reception of signals or messages, etc., via a wireless network (e.g., after being down-converted by wireless transceiver 1302, for example). Processor 1304 may be programmable and capable of executing software or other instructions stored in memory or on other computer media to perform the various tasks and functions described above, such as one or more of the tasks or methods described above. Processor 1304 may be (or may include), for example, hardware, programmable logic, a programmable processor that executes software or firmware, and/or any combination of these. Using other terminology, processor 1304 and transceiver 1302 together may be considered as a wireless transmitter/receiver system, for example.

In addition, referring to FIG. 7, a controller (or processor) 1308 may execute software and instructions, and may provide overall control for the station 1300, and may provide control for other systems not shown in FIG. 7, such as controlling input/output devices (e.g., display, keypad), and/or may execute software for one or more applications that may be provided on wireless station 1300, such as, for example, an email program, audio/video applications, a word processor, a Voice over IP application, or other application or software.

In addition, a storage medium may be provided that includes stored instructions, which when executed by a controller or processor may result in the processor 1304, or other controller or processor, performing one or more of the functions or tasks described above.

According to another example embodiment, RF or wireless transceiver(s) 1302A/1302B may receive signals or data and/or transmit or send signals or data. Processor 1304 (and possibly transceivers 1302A/1302B) may control the RF or wireless transceiver 1302A or 1302B to receive, send, broadcast or transmit signals or data.

Example embodiments are provided or described for each of the example methods, including: An apparatus (e.g., 1300, FIG. 7) including means (e.g., processor 1304, RF transceivers 1302A and/or 1302B, and/or memory 1306, in FIG. 7) for carrying out any of the methods; a non-transitory computer-readable storage medium (e.g., memory 1306, FIG. 7) comprising instructions stored thereon that, when executed by at least one processor (processor 1304, FIG. 7), are configured to cause a computing system (e.g., 1300, FIG. 7) to perform any of the example methods; and an apparatus (e.g., 1300, FIG. 7) including at least one processor (e.g., processor 1304, FIG. 7), and at least one memory (e.g., memory 1306, FIG. 7) including computer program code, the at least one memory (1306) and the computer program code configured to, with the at least one processor (1304), cause the apparatus (e.g., 1300) at least to perform any of the example methods.

Embodiments of the various techniques described herein may be implemented in digital electronic circuitry, or in computer hardware, firmware, software, or in combinations of them. Embodiments may be implemented as a computer program product, i.e., a computer program tangibly embodied in an information carrier, e.g., in a machine-readable storage device or in a propagated signal, for execution by, or to control the operation of, a data processing apparatus, e.g., a programmable processor, a computer, or multiple computers. Embodiments may also be provided on a computer readable medium or computer readable storage medium, which may be a non-transitory medium. Embodiments of the various techniques may also include embodiments provided via transitory signals or media, and/or programs and/or software embodiments that are downloadable via the Internet or other network(s), either wired networks and/or wireless networks. In addition, embodiments may be provided via machine type communications (MTC), and also via an Internet of Things (IOT).

As used in this application, the term ‘circuitry’ or “circuit” refers to all of the following: (a) hardware-only circuit implementations, such as implementations in only analog and/or digital circuitry, and (b) combinations of circuits and soft-ware (and/or firmware), such as (as applicable): (i) a combination of processor(s) or (ii) portions of processor(s)/software including digital signal processor(s), software, and memory (ies) that work together to cause an apparatus to perform various functions, and (c) circuits, such as a microprocessor(s) or a portion of a microprocessor(s), that require software or firmware for operation, even if the software or firmware is not physically present. This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer, or it may be distributed amongst a number of computers.

Furthermore, embodiments of the various techniques described herein may use a cyber-physical system (CPS) (a system of collaborating computational elements controlling physical entities). CPS may enable the embodiment and exploitation of massive amounts of interconnected ICT devices (sensors, actuators, processors microcontrollers, . . . ) embedded in physical objects at different locations. Mobile cyber physical systems, in which the physical system in question has inherent mobility, are a subcategory of cyber-physical systems. Examples of mobile physical systems include mobile robotics and electronics transported by humans or animals. The rise in popularity of smartphones has increased interest in the area of mobile cyber-physical systems. Therefore, various embodiments of techniques described herein may be provided via one or more of these technologies.

A computer program, such as the computer program(s) described above, can be written in any form of programming language, including compiled or interpreted languages, and can be deployed in any form, including as a standalone program or as a module, component, subroutine, or other unit or part of it suitable for use in a computing environment. A computer program can be deployed to be executed on one computer or on multiple computers at one site or distributed across multiple sites and interconnected by a communication network.

Method steps may be performed by one or more programmable processors executing a computer program or computer program portions to perform functions by operating on input data and generating output. Method steps also may be performed by, and an apparatus may be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer, chip or chipset. Generally, a processor will receive instructions and data from a read-only memory or a random access memory or both. Elements of a computer may include at least one processor for executing instructions and one or more memory devices for storing instructions and data. Generally, a computer also may include or be operatively coupled to receive data from or transfer data to, or both, one or more mass storage devices for storing data, e.g., magnetic, magnetooptical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, embodiments may be implemented on a computer having a display device, e.g., a cathode ray tube (CRT) or liquid crystal display (LCD) monitor, for displaying information to the user and a user interface, such as a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments may be implemented in a computing system that includes a backend component, e.g., as a data server, or that includes a middleware component, e.g., an application server, or that includes a frontend component, e.g., a client computer having a graphical user interface or a Web browser through which a user can interact with an embodiment, or any combination of such backend, middleware, or frontend components. Components may be interconnected by any form or medium of digital data communication, e.g., a communication network. Examples of communication networks include a local area network (LAN) and a wide area network (WAN), e.g., the Internet.

While certain features of the described embodiments have been illustrated as described herein, many modifications, substitutions, changes and equivalents will now occur to those skilled in the art. It is, therefore, to be understood that the appended claims are intended to cover all such modifications and changes as fall within the true spirit of the various embodiments.

What is claimed is:

1. An apparatus comprising:
at least one processor; and
at least one memory storing instructions that, when executed by the at least one processor, cause the apparatus at least to perform:
determining based on a received reference signal from a network node, channel information;
applying as an input to an artificial intelligence and machine learning (AI/ML) model the channel information;
determining, based on an output of the AI/ML model, whether to measure an upcoming positioning reference signal (PRS) transmitted by the network node; and
in response to the determination to measure the upcoming PRS, performing a positioning measurement based on the upcoming PRS, and
transmitting to the network node the positioning measurement.

2. The apparatus of claim 1, wherein the output from the AI/ML model comprises at least one of:
an indication of whether to measure the upcoming PRS;
an indication of whether the positioning measurement based on the upcoming PRS can meet a measurement quality requirement;
an information associated with a success probability that the positioning measurement based on the upcoming PRS can meet the measurement quality requirement;
an indication whether the positioning measurement based on the upcoming PRS can meet the measurement quality requirement with the success probability being greater than or equal to a first threshold value;
a first time duration for which the positioning measurement based on one or more upcoming PRSs can meet the measurement quality requirement with the success probability being greater than or equal to the first threshold value; or
a second time duration for which the positioning measurement based on the upcoming PRS can be skipped.

3. The apparatus of claim 2, wherein the measurement quality requirement comprises at least one of:
timing information of the positioning measurement;
an expected measurement accuracy of the measurement; or
a reference signal received power (RSRP) of a reference signal (RS) that is used for the positioning measurement.

4. The apparatus of claim 2, wherein the apparatus is further caused to perform receiving from the network node, at least one of the measurement quality requirement or the first threshold value.

5. The apparatus of claim 2, wherein the determining whether to measure the upcoming PRS comprises comparing the success probability with the first threshold value.

6. The apparatus of claim 2, wherein the apparatus is further caused to perform skipping the positioning measurement for a time period shorter than the second time duration, based on at least one of:
a mobility condition;
a variation of a channel quality;
a variation of a channel state; or
a predicted channel quality over the time period.

7. The apparatus of claim 2, wherein the apparatus is further caused to perform in response to an indication that the positioning measurement based on the upcoming PRS cannot meet the measurement quality requirement with the success probability being greater than or equal to the first threshold value, comparing the success probability with a second threshold value smaller than the first threshold value.

8. The apparatus of claim 7, wherein the apparatus is further caused to perform receiving from the network node, the second threshold value.

9. The apparatus of claim 1, wherein the apparatus is further caused to perform receiving, by the apparatus from the network node, at least one of configuration of the AI/ML model, or training information of the AI/ML model, wherein the AI/ML model is used to determine whether to perform the positioning measurement based on the upcoming PRS.

10. The apparatus of claim 1, wherein the apparatus is further caused to perform receiving, by the apparatus from the network node, an indication to perform an overhead reduction of positioning measurements by using the AI/ML model.

11. The apparatus of claim 1, wherein the channel information is at least one of:
an estimated channel information; or
a predicted channel information.

12. The apparatus of claim 1, wherein the channel information is determined based on a measurement of a reference signal (RS), wherein the RS comprises a channel state information reference signal (CSI-RS).

13. The apparatus of claim 1, wherein the apparatus is further caused to perform:
determining, based on the output of the AI/ML model, not to measure the upcoming PRS transmitted by the network node; and
in response to the determination not to measure the upcoming PRS:
skipping the performing the positioning measurement based on the upcoming PRS; and
skipping transmitting to the network node the positioning measurement.

14. An apparatus comprising:
at least one processor; and
at least one memory
storing instructions that, when executed by the at least one processor, cause the apparatus at least to perform:
transmitting to a user device, at least one of configuration of an artificial intelligence and machine learning (AI/ML) model, or training information of the AI/ML model, wherein the AI/ML model is used to determine whether to perform a positioning measurement based on an upcoming positioning reference signal (PRS) transmitted by the apparatus;
transmitting a PRS for the positioning measurement; and
receiving the positioning measurement based on the transmitted PRS.

15. The apparatus of claim 14, wherein an output from the AI/ML model comprises at least one of:
an indication of whether to measure the upcoming PRS;
an indication of whether the positioning measurement based on the upcoming PRS can meet a measurement quality requirement;
an information associated with a success probability that the positioning measurement based on the upcoming PRS can meet the measurement quality requirement;
an indication whether the positioning measurement based on the upcoming PRS can meet the measurement quality requirement with the success probability being greater than or equal to a first threshold value;
a first time duration for which the positioning measurement based on one or more upcoming PRSs can meet the measurement quality requirement with the success probability being greater than or equal to the first threshold value; or
a second time duration for which the positioning measurement based on the upcoming PRS should be skipped.

16. The apparatus of claim 15, wherein the apparatus is further caused to perform transmitting by the apparatus, at least one of the measurement quality requirement or the first threshold value.

17. The apparatus of claim 16, wherein the measurement quality requirement comprises at least one of:
timing information of a measurement;
an expected measurement accuracy of the measurement; or
a reference signal received power (RSRP) of a reference signal (RS) that is used for the measurement.

18. The apparatus of claim 14, wherein the apparatus is further caused to perform transmitting to the user device, an indication to perform an overhead reduction of positioning measurements by using the AI/ML model.

19. The apparatus of claim 14, wherein the apparatus is further caused to perform transmitting to a location management function (LMF), the positioning measurement.

20. A method comprising:
determining by a user device, based on a received reference signal from a network node, channel information;
applying as an input to an artificial intelligence and machine learning (AI/ML) model the channel information;
determining, based on an output of the AI/ML model, whether to measure an upcoming positioning reference signal (PRS) transmitted by the network node; and
in response to the determination to measure the upcoming PRS, performing a positioning measurement based on the upcoming PRS, and
transmitting to the network node the positioning measurement.
